(19) United States
(12) Patent Application Publication
(10) Pub. No.: US 2005/0036067 A1
(43) Pub. Date: Feb. 17, 2005

(54) Variable perspective view of video images

(76) Inventors: Kim Annon Ryal, Poway, CA (US); Gary Skerl, Poway, CA (US)

Correspondence Address: MILLER PATENT SERVICES, 2500 DOCKERY LANE, RALEIGH, NC, 27606, US

(21) Appl. No.: 10/634,546

(22) Filed: Aug. 5, 2003

(51) Int. Cl. H04N 5/45

(52) U.S. Cl. 348/565; 345/629

(57) ABSTRACT

A method of displaying an view on an electronic display consistent with certain embodiments involves presenting a main window and a secondary window adjacent the main window. A first and a second image are provided, wherein the first and second images overlap one another by at least 50%. A portion of the first image is removed and a remainder of the first image is displayed in the main window. A portion of the second image is removed and a remainder of the second image is displayed in the secondary window. In this manner, a composite image made up of the remainder of the first image displayed adjacent the remainder of the second image provides a selected view extracted from a total scene captured in the sum of the first and second images. This abstract is not to be considered limiting, since other embodiments may deviate from the features described in this abstract without departing from the invention.

### TECHNICAL FIELD

Certain embodiment of this invention relate generally to the field of video display. More particularly, in certain embodiments, this invention relates to display of a variable perspective video image by use of a television's picture-in-picture feature and multiple video streams.

### BACKGROUND

The DVD (Digital Versatile Disc) video format provides for multiple viewing angles. This is accomplished by providing multiple streams of video taken from multiple cameras. The idea is for the multiple cameras to take multiple views of the same scene that the user may select from. Using this video format, the viewer with an appropriately equipped playback device can select the view that is most appealing. While this feature is available, heretofore, it has been sparsely utilized. Moreover, the available perspectives are from several distinct camera angles that are discretely selected by the user to provide an abrupt change in perspective.

### OVERVIEW OF CERTAIN EMBODIMENTS

The present invention relates, in certain embodiments, generally to display of a selective view of a scene using a television's picture-in-picture feature. Objects, advantages and features of the invention will become apparent to those skilled in the art upon consideration of the following detailed description of the invention.

A method of displaying a view of a scene on an electronic display consistent with certain embodiments involves presenting a main window and a secondary window adjacent the main window. A first and a second image are provided, wherein the first and second images overlap one another by at least 50%. A portion of the first image is removed and a remainder of the first image is displayed in the main window. A portion of the second image is removed and a remainder of the second image is displayed in the secondary window. In this manner, a composite image made up of the remainder of the first image displayed adjacent the remainder of the second image provides a selected view extracted from a total scene captured in the sum of the first and second images.

A device for producing a view of a scene consistent with certain embodiments of the invention has a demultiplexer that receives an input stream as an input and produces a first video stream and a second video stream as outputs, wherein the first video stream represents a first video image of the scene and wherein the second video stream represents a second video image of the scene. A main decoder receives the first video stream and a secondary decoder receives the secondary video stream. Portions of the first and second images are removed to leave remaining portions of the first and second images. An image combiner combines the first and second images to produce a composite image, wherein the composite image represent a view of the scene.

A method of creating multiple images for facilitating display of a selected view of a scene consistent with certain embodiments involves capturing a first image of a scene from a location using a first camera angle; capturing a second image of the scene from the location using a second camera angle, wherein the first and second images have at least 50% overlap; associating the first image with a first packet identifier; associating the second image with a second packet identifier; and formatting the first and second images in a digital format.

Another method of displaying an image on an electronic display consistent with certain embodiments of the invention involves presenting a main window; presenting a secondary window adjacent the main window; providing a first and a second image, wherein the first and second images overlap one another; stitching together the first and second images to produce a panoramic image; and from the panoramic image, generating first and second display images for display in the main and secondary windows such that a view from the panoramic image spans the main and secondary windows.

Another method of displaying a view of a scene on an electronic display consistent with certain embodiments involves presenting a main window; presenting a secondary window adjacent the main window; providing a first and a second image, wherein the first and second images overlap one another by J%; removing a portion of the first image and displaying a remainder of the first image in the main window; removing a portion of the second image and displaying a remainder of the second image in the secondary window; and wherein, a composite image comprising the remainder of the first image displayed adjacent the remainder of the second image provides a selected view extracted from a total scene captured in the sum of the first and second images.

The above overviews are intended only to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1, which is made up of FIG. 1a, 1b and 1c, illustrates multiple image capture by multiple cameras in a manner consistent with certain embodiments of the present invention.

FIG. 2 is a composite image made up of the three overlapping images captured in FIG. 1 in a manner consistent with certain embodiments of the present invention.

FIG. 3 is a flow chart of an image capture process consistent with certain embodiments of the present invention.

FIG. 4 is a flow chart of an image presentation process consistent with certain embodiments of the present invention.

FIG. 5, which is made up of FIGS. 5a-5f, depicts panning to the right in a manner consistent with certain embodiments of the present invention.

FIG. 6 is a block diagram of an exemplary receiver or playback device suitable for presenting a panned view to a display in a manner consistent with certain embodiments of the present invention.

FIG. 7 is a flow chart depicting a process for panning right in a manner consistent with certain embodiments of the present invention.

FIG. 8 is a flow chart depicting a process for panning left in a manner consistent with certain embodiments of the present invention.

FIG. 9 is a flow chart of an image capture process for an alternative embodiment consistent with the present invention.

FIG. 10 is a flow chart of an image presentation process consistent with certain embodiments of the present invention.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

For purposes of this document, the term “image” is intended to mean an image captured by a camera or other recording device and the various data streams that can be used to represent such an image. The term “view” is used to describe the representation of an image or a combination of images presented to a viewer. The term “scene” is used to mean a sum of all images captured from multiple camera angles.

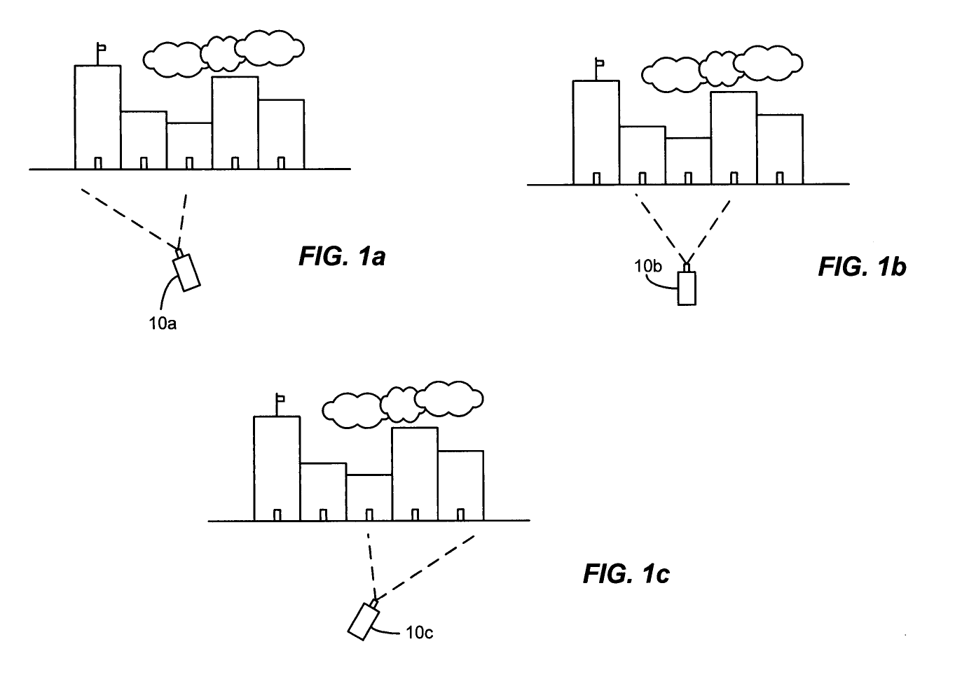

The present invention, in certain embodiments thereof, provide a mechanism for permitting a viewer to view an apparently continuously variable perspective of an image by panning across the scene. This process is made possible, in certain embodiments by starting with multiple perspectives being captured by a video tape recorder or film camera (either still or full motion). Turning now to FIG. 1, made up of FIG. 1a, 1b and 1c, the process begins with capturing two or more (three are illustrated, but this should not be considered limiting) images of a scene. In FIG. 1a, the left side of a city-scape scene is captured as an image by camera 10a. In FIG. 1b, the center of a city-scape scene is captured as an image by camera 10b. In FIG. 1c, the left side of a city-scape scene is captured as an image by camera 10c.

Cameras 10a, 10b and 10c may be integrated into a single camera device or separate devices may be used. But in any event, the cameras should capture the images from the same location with different viewing angles. However, as long as the images can be made to overlap as described, any process for creating the multiple overlapping images is acceptable within the present invention. Such a camera device may incorporate any number 2 through N cameras. Any number of cameras and camera angles can be provided and can even be arranged to provide a full 360 degrees by providing enough camera angles such that a pan can be carried out in a full circle. Moreover, although this illustrative embodiment only shows three camera angles with the cameras angles capturing 50% overlap in the horizontal direction, vertically overlapping camera angles can also be used to facilitate panning up or down or in any direction when multiple camera angles are provided with both horizontal and vertical coverage. In this preferred embodiment, the cameras capture images that overlap the adjacent images by at least 50%, but in other embodiments, minimal overlap is required, as will be discussed later. These images can then be stored and digitally transmitted as described later.

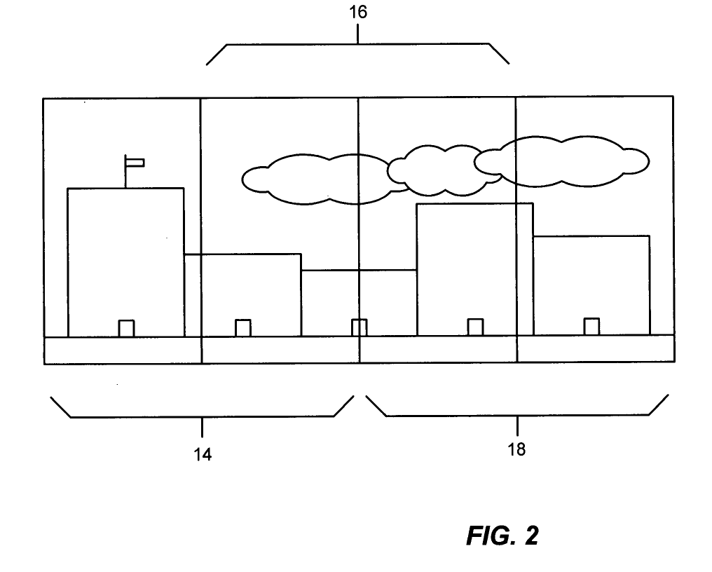

Thus, by reference to FIG. 2 it can be seen that three separate images 14, 16 and 18 with 50% overlap are obtained from cameras 10a, 10b and 10c respectively to represent the exemplary city-scape scene. By overlaying these images with the overlaps aligned as shown, the image makes up a wider perspective of the scene than any single camera captures. Using exactly 50% overlay, three camera images can create a superimposed image that is twice the width of a single camera's image. This superimposed image represents all available views of the scene for this example.

The 50% overlap provides for the ability to have fixed size windows for the main and secondary (PIP) windows in order to provide the desired ability to pan. However, one skilled in the art will appreciate that by also providing for variability of the window sizes, a smaller amount of overlap can be used to still achieve the panning effect. This is accomplished by adjusting the size of the view displayed in each window (one expands while the other contracts) in order to simulate the pan. When a limit on an image is reached, the window sizes are again changed and new set of images are used to create the next panned view.

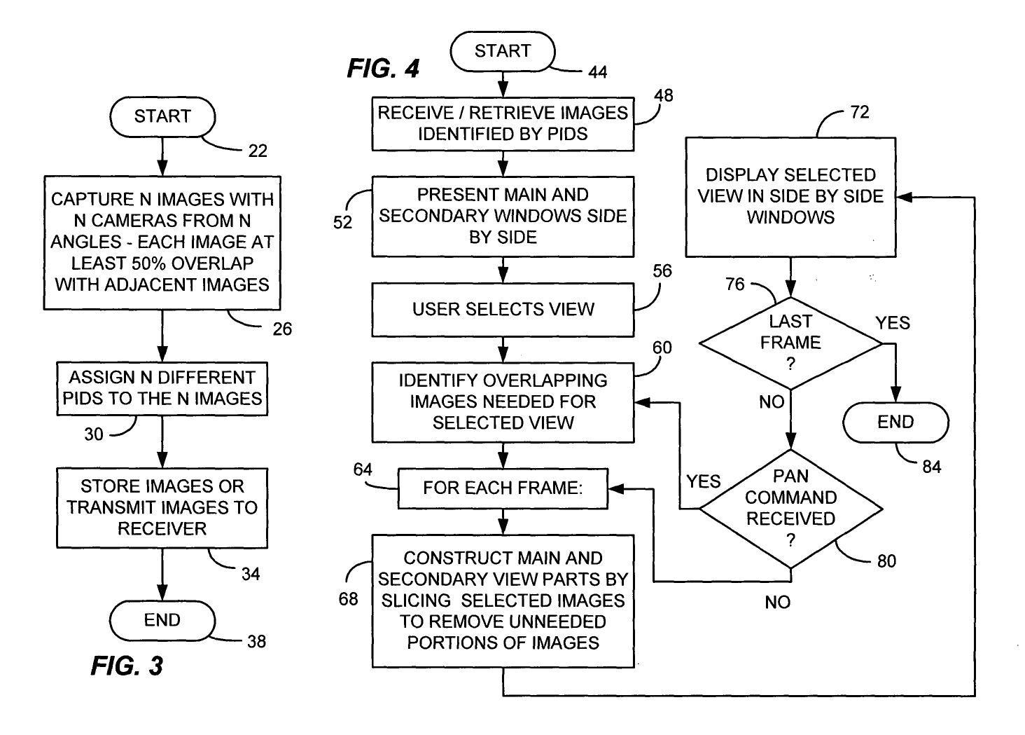

The process of capturing and utilizing these images, is described in the process of the flow chart of FIG. 3. This flow chart summarizes the process described above starting at 22. At 26, the N images of a particular scene are captured from N cameras (or the equivalent) with each image overlapping adjacent images by at least 50%. In accordance with this embodiment, the N different images can be formatted as an MPEG (Moving Pictures Expert Group) format or other suitable digital format. In so doing, each of the N images and associated data streams can be assigned a different packet identifier (PID) or set of packet identifiers (or equivalent packet identification mechanism) at 30 in order to associate each packet with the data stream or file of a particular image. Once the images are so formatted, they can be stored and/or transmitted to a receiver at 34. This process ends at 38.

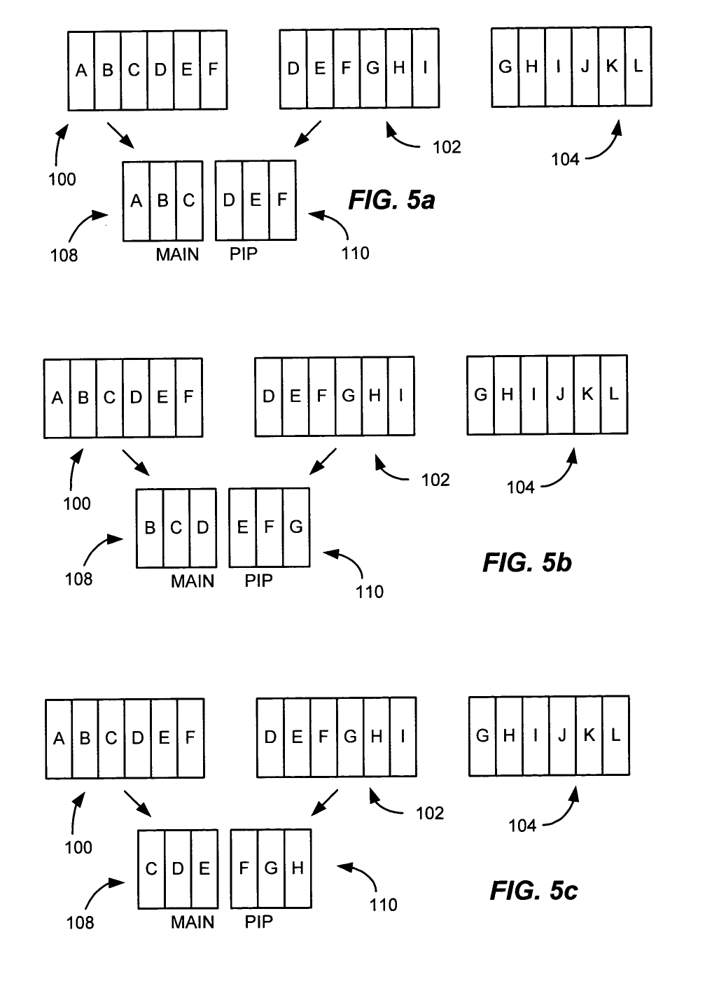

Once these images are stored on an electronic storage medium or transmitted to the receiver, a panning operation can be carried out by the receiver or a media player under user control as described in one embodiment by the flow chart of FIG. 4 starting at 44. The images, identified by distinct PIDs for each image data stream, are received or retrieved from storage, or downloaded or streamed at 48. A pair of windows, e.g., in the case of a television display, a main window and a picture-in-picture (PIP) window, are displayed adjacent one another at 52. For simplicity of explanation, it will be assumed that the main window is always to the left and the PIP window is always to the right. The windows can occupy the left and right halves of the display screen if desired and are one half the width of a normal display. A user selected (or initially a default) view 56 of the images is displayed in the two side by side windows to represent a single view.

In order to display the selected view, the overlapping images and portions of overlapping images are identified at 60 to produce the selected view. Then, for each frame of the video image at 64, the main and secondary views are constructed at 68 by slicing selected portions of the selected images to remove the unused portions. One of the sliced images is displayed on the main window while the other is displayed on the secondary (e.g., PIP) window at 72. Since the windows are positioned side by side, the two half images are displayed to produce the whole selected view of the scene to the viewer. If the last frame has not been reached at 76 and a pan command has not been received at 80, the process proceeds as described for each frame in the data streams. Once the last frame is received, the process ends at 84. If a pan command is issued by the user to either pan left or right (or up or down or in any other direction in other embodiments), control returns to 60 where the process again identifies the images needed to produce the selected view.

As will become clear later, by use of the present process, very little computing power is needed to generate a panning effect as described. The pan command received (e.g., by a left or right arrow control on a remote controller), the images are selected and sliced according to the degree of left or right pan requested. Since each data stream representing each image is easily identified by the PID or PIDs associated therewith, the receiver can easily divert one stream to a main decoder and a secondary stream to a secondary decoder (e.g., a PIP decoder). The decoders can further be instructed to slice the image vertically (or horizontally) in an appropriate location and the respective images displayed on the main and secondary windows of the display.

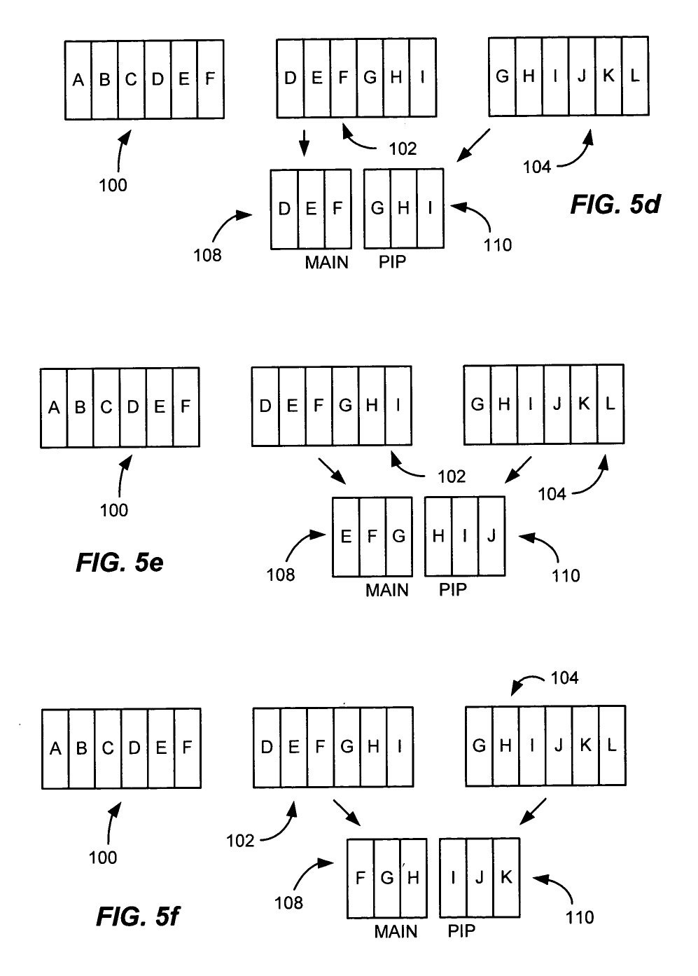

The process of FIG. 4 above is illustrated in FIGS. 5a-5f. Assume for purposes of this illustration, that a full image can be represented by six vertical columns of pixels (or sets of pixels). Clearly, most images will require far more columns of pixels to provide a meaningful display, but, for ease of explanation, consider that only six are required. Consistent with a 50% overlap in the images, a first image 100 contains pixel columns A through F, second image 102 contains pixel columns D through I and third image 104 contains pixel columns G through L. This provides enough redundant information to permit assembly of any desired view of the scene using two of the video data streams containing adjacent overlapping images. To display a leftmost view of the scene as shown in FIG. 5a, columns A, B and C can be extracted from image 100 and displayed on the main window 108, while columns D, E and F extracted from image 102 and displayed on the PIP or other secondary window 110. (Alternatively, all six columns of pixels can be taken from image 100.)

If a command is received to pan to the right by one pixel column, the image is constructed as shown in FIG. 5b. To display this view, columns B, C and D can be extracted from image 100 and displayed on the main window 108, while columns E, F and G extracted from image 102 and displayed on the PIP or other secondary window 110.

If a command is received to again pan to the right by one pixel column, the image is constructed as shown in FIG. 5c. To display this view, columns C, D and E can be extracted from image 100 and displayed on the main window 108, while columns F, G and H are extracted from image 102 and displayed on the PIP or other secondary window 110.

If another command is received to pan to the right by one pixel column, the image is constructed as shown in FIG. 5d. To display this view, columns D, E and F can be extracted from image 100 or image 102 and displayed on the main window 108, while columns G, H and I can be extracted from image 102 or 104 and displayed on the PIP or other secondary window 110.

If a command is again received to pan to the right by one pixel column, the image is constructed as shown in FIG. 5e. To display this view, columns E, F and G can be extracted from image 102 and displayed on the main window 108, while columns H, I and J extracted from image 104 and displayed on the PIP or other secondary window 110.

Finally, for purposes of this example, if another command is received to pan to the right by one pixel column, the image is constructed as shown in FIG. 5f. To display this view, columns F, G and H can be extracted from image 102 and displayed on the main window 108, while columns 1, J and K extracted from image 104 and displayed on the PIP or other secondary window 110.

While the example of FIG. 5 depicts only right panning, those skilled in the art will readily understand, upon consideration of the present teaching, the operation of a left pan (or an up or down pan). A left pan scenario can be visualized by starting with FIG. 5f and working backwards toward FIG. 5a.

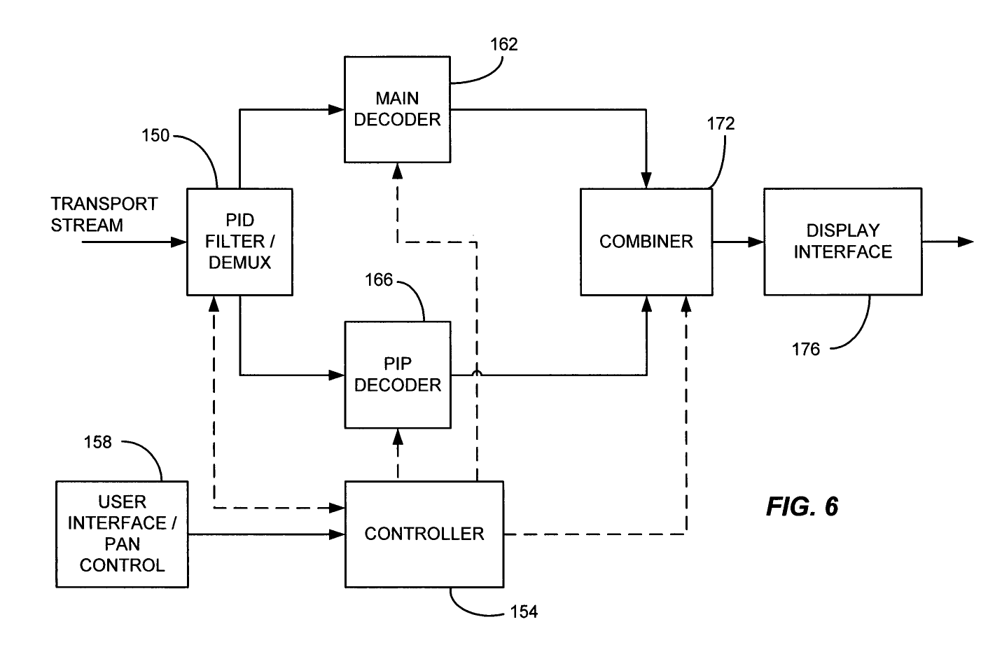

A receiver (e.g., a television set top box, or television) or playback system (e.g., a DVD player or personal computer system) suitable for presenting such a panning view to a suitable display is depicted in block diagram form in FIG. 6. In this exemplary system, a transport stream containing possibly many video and associated data streams is provided to a demultiplexer 150 serving as a PID filter that selects a stream of video data based upon the PID as instructed by a controller, e.g., a microcomputer, 154. Controller 154 operates under a user's control via a user interface 158 wherein the user can provide instructions to the system to pan left or right (or up or down, etc.). Controller 154 provides oversight and control operations to all functional blocks as illustrated by broken lined arrows.

Controller 154 instructs demultiplexer 150 which video streams (as identified by PIDs) are to be directed to a main decoder 162 and a secondary decoder 166 (e.g., a PIP decoder). In this manner, the 50% or greater overlapped images can individually each be directed to a single decoder for decoding and slicing. The slicing can be carried out in the decoders themselves under program control from the controller 154, or may be carried out in a separate slicing circuit (not shown) or using any other suitable mechanism. In this manner, no complex calculations are needed to implement the panning operation. Under instructions from controller 154, the demultiplexer 150 directs a selected stream of video to the main decoder 162 and the secondary decoder 166. The controller instructs the main decoder 162 and secondary decoder 166 to appropriately slice their respective images to create the desired view (in this embodiment). The sliced images are then combined in a combiner 172 that creates a composite image suitable for display on the display, with the main and secondary images situated adjacent one another to create the desired view. In certain other embodiments, the slicing of the individual images can be carried out in the combiner 172 under direction of the controller 154. Display interface 176 places the composite image from combiner 154 into an appropriate format (e.g., NTSC, PAL, VSGA, etc.) for display on the display device at hand.

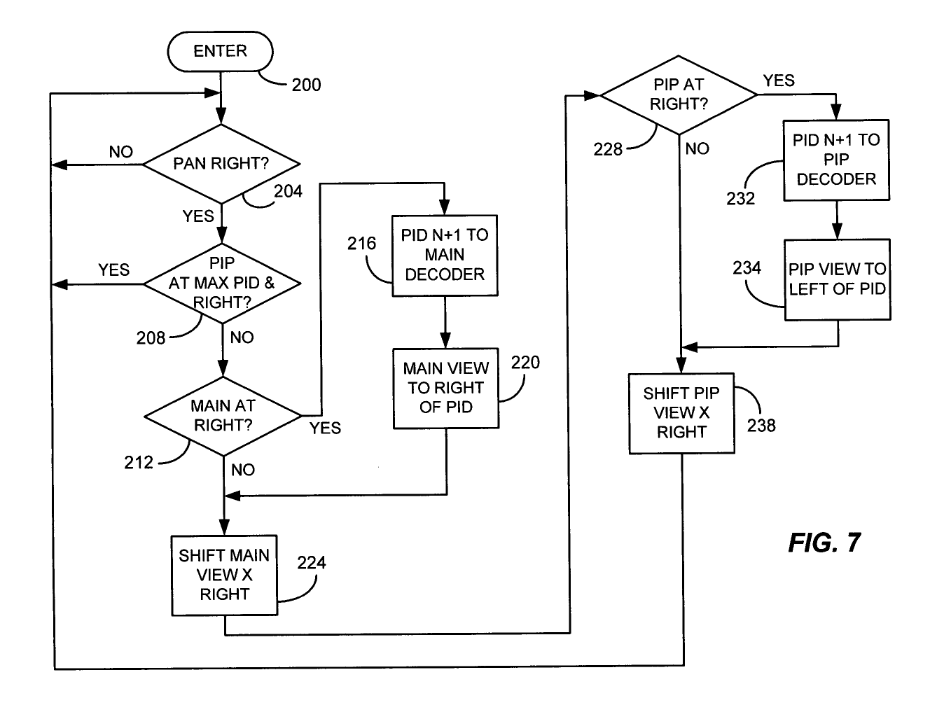

FIG. 7 describes one exemplary process that can be used by controller 154 in controlling a right pan operation starting at 200. For purposes of this process, the PID values assigned to the N video streams are considered to be numbered from left image to right image as PID 0, PID 1,. . . , PID N-2, PID N-1. In this manner, the terminology of minimum or maximum PID is associated with leftmost image or rightmost image respectively, etc. At 204, if a pan right command is received, control passes to 208, otherwise, the process awaits receipt of a pan right command. If the secondary (PIP) display is displaying the video stream with the greatest PID value and is all the way to the right, no action is taken at 208 since no further panning is possible to the right. If not at 208, and if the main display is at the right of the current image at 212, then the video stream for the next higher value PID is sent to the main decoder at 216. Next the main view is placed at the right of the new PID at 220 and control passes to 224. At 224, the main view is shifted by X (corresponding to a shift amount designated in the shift right command. If the main view is not at the right of the current image at 212, control passes directly to 224, bypassing 216 and 220.

At 228, if the secondary display is all the way to the right of it's current image, the PID value is incremented at 232 to move to the next image to the right and the new PID valued video stream is sent to the secondary decoder. At 234 the secondary view is set to the left side of the image represented by the current PID value. Control then passes to 238 where the PIP view is also shifted to the right by x and control returns to 204 to await the next pan command. If the secondary view is not at the right of the current image at 228, control passes directly from 228 to 238, bypassing 232 and 234.

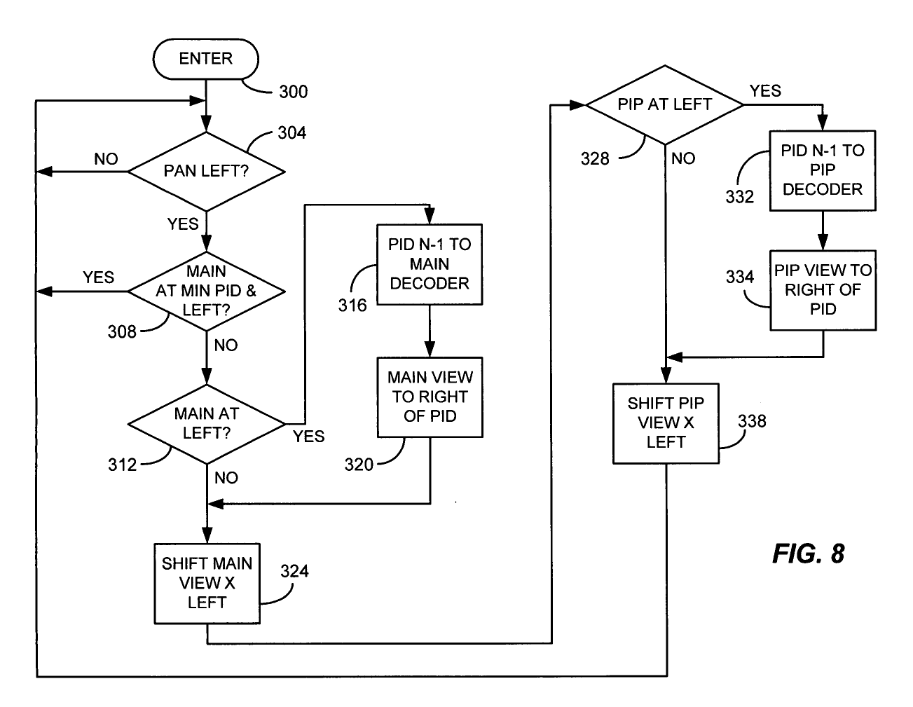

FIG. 8 describes one exemplary process that can be used by controller 154 in controlling a left pan operation starting at 300. At 304, if a pan left command is received, control passes to 308, otherwise, the process awaits receipt of a pan left command. If the secondary (PIP) display is displaying the video stream with the smallest PID value and is all the way to the left, no action is taken at 308 since no further panning is possible to the left. If not at 308, and if the main display is at the left of the current image at 312, then the video stream for the next lower value PID is sent to the main decoder at 316. Next the main view is placed at the right of the new PID at 320 and control passes to 324. At 324, the main view is shifted by X (corresponding to a shift amount designated in the shift right command) to the left. If the main view is not at the left of the current image at 312, control passes directly to 324, bypassing 316 and 320.

At 328, if the secondary display is all the way to the left of it's current image, the PID value is incremented at 332 to move to the next image to the left and the new PID valued video stream is sent to the secondary decoder. At 334 the secondary view is set to the right side of the image represented by the current PID value. Control then passes to 338 where the PIP view is also shifted to the left by x and control returns to 304 to await the next pan command. If the secondary view is not at the left of the current image at 328, control passes directly from 328 to 338, bypassing 332 and 334.

The above described process are easily implemented with relatively low amounts of computing power, since the video streams can be readily distinguished by their PID and directed to the appropriate decoder. The decoder or a combiner or other signal processing device can then be programmed to slice the image as desired to create the left and right halves of the particular view selected.

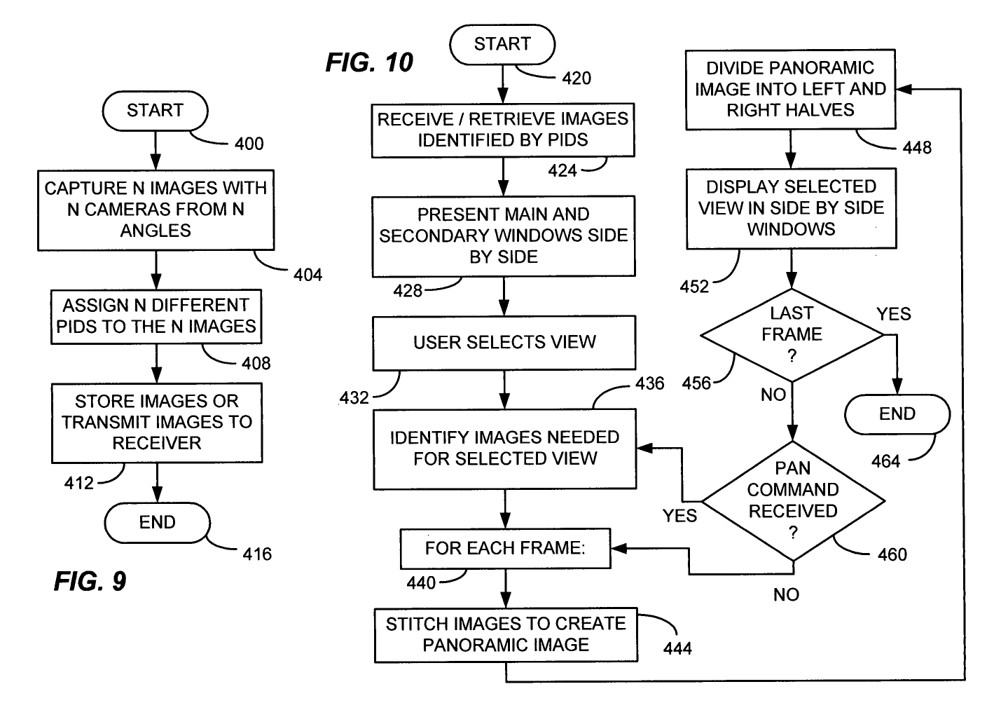

In an alternative embodiment, a similar effect can be achieved without need for the 50% or more overlap in the captured images, but at the expense of possibly greater processing power at the receiver/decoder side. FIG. 9 is a flow chart of an image capture process for such alternative embodiment consistent with the present invention starting at 400. This process is similar to the prior process except for the lack of constraint on the amount of overlap. At 404, N images are captured from N cameras or equivalent from N different angles, but with the cameras located at the same point. In this case, the images are only slightly overlapped to facilitate stitching together of the images. Theoretically, a continuous pan can be achieved with no overlap if the images begin and end precisely at the same line. For purposes of this document, images that begin and end at substantially the same line will also be considered to be overlapped if they can be stitched together to render a composite panoramic scene. At 408, N different PID values are assigned to the N images that are then stored or transmitted to a receiver at 412. The process ends at 416.

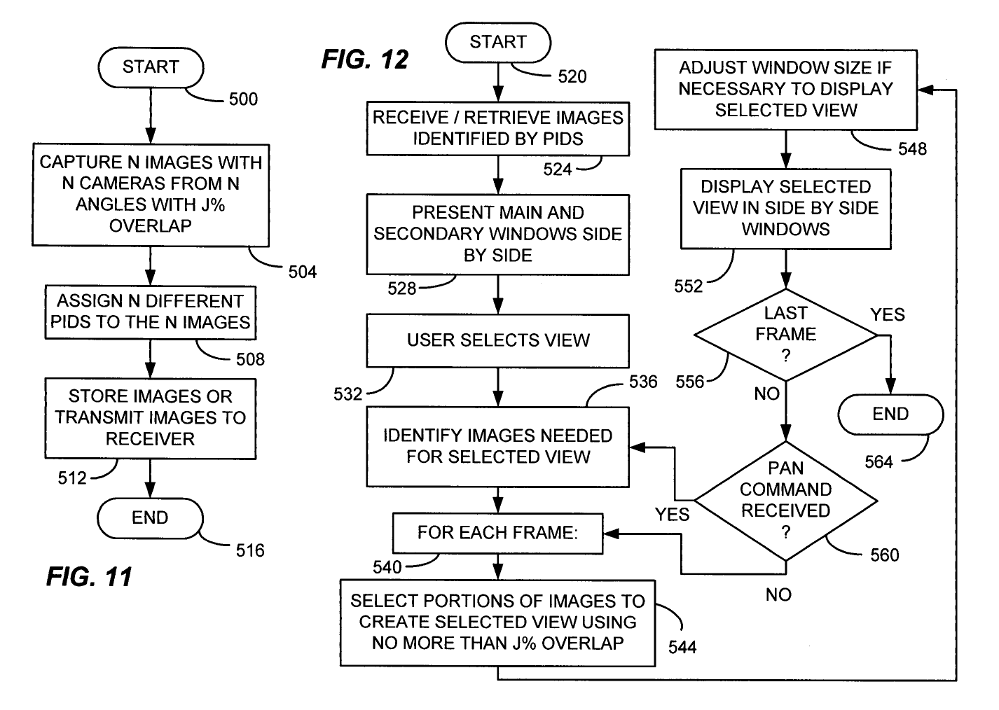

Once this set of images is captured using the process just described, the decoding or playback process can be carried out. FIG. 10 is a flow chart of an image presentation process consistent with this alternative embodiment of the present invention starting at 420. The images identified by PIDs or other identifiers are received or retrieved at 424. At 428, main and secondary windows are presented side by side and adjacent one another. A view is selected by the user at 432, or initially, a default view is established. The process identifies which of the N images are needed for the selected view at 436. At 440, for each frame the images are stitched together to create what amounts to a panoramic image from two (or more) adjacent images using known image stitching technology at 444. This panoramic image is then divided into right and left halves at 448 and the right and left halves are sent to a decoder for display side by side in the main and secondary windows at 452. If the last frame has not been reached at 456, and no command has been received to execute a pan at 460, the process continues at 440 with the next frame. If, however, the user executes another pan command at 460, control returns to 436 where the new images needed for the view are selected by virtue of the pan command and the process continues. When the last frame is received at 456, the process ends at 464.

In another alternative embodiment, a similar effect can again be achieved without need for the 50% or more overlap in the captured images. FIG. 11 is a flow chart of an image capture process for such alternative embodiment consistent with the present invention starting at 500. This process is similar to the prior image capture processes. At 504, N images are captured from N cameras or equivalent from N different angles, but with the cameras located at the same point. In this case, the images are overlapped by any selected overlap of J% (e.g., 10%, 25, 40%, etc.). At 508, N different PID values are assigned to the N images that are then stored or transmitted to a receiver at 512. The process ends at 516. Again, the number of images can be any suitable number of two or more images and may even be arranged to produce a 360 degree pan if desired, as with the other embodiments.

Once this set of images is captured using the process just described, the decoding or playback process can be carried out. FIG. 12 is a flow chart of an image presentation process consistent with this additional alternative embodiment of the present invention starting at 520. The images identified by PIDs or other identifiers are received or retrieved at 524. At 528, main and secondary windows are presented side by side and adjacent one another. However, in this embodiment, the size of the windows is dependent upon the amount of overlap and the location of the view.

A view is selected by the user at 532, or initially, a default view is established. The process, at 536, identifies which of the N images are needed for the selected view. At 540, for each frame, portions of images are selected to create the selected view by using no more than the available J% overlap at 544. The window sizes are selected to display the desired view by presenting right and left portions of a size determined by the view and the available overlap at 548. The right and left portions of the view are sent to decoders for display side by side in the main and secondary windows at 552. If the last frame has not been reached at 556, and no command has been received to execute a pan at 560, the process continues at 540 with the next frame. If, however, the user executes another pan command at 560, control returns to 536 where the new images needed for the view selected by virtue of the pan command are presented and the process continues. When the last frame is received at 556, the process ends at 564.

In this embodiment, each frame of a view may be produced by not only selection of a particular segment of a pair of images for display, but also by possibly adjusting the size of the windows displaying the images. By way of example, and not limitation, assume that the image overlap (J) is 25% on adjacent images. The far left image may be displayed in a left (main) window occupying 75% of the display, and in a left (secondary) window displaying 25% of the adjacent window. When a far right image is reached (again having 25% overlap with the image to its immediate left, the image can continue to pan by changing the sizes of the two windows. The left window decreases in size while the right window increases in size until the far right is reached. At this point, the left window would occupy 25% of the view while the right window would occupy 75% of the view.

While the present invention has been described in terms of exemplary embodiments in which left and right panning are described, in other embodiments, panning can also be carried out up and down or at any other angle. This is accomplished using similar algorithms to those described above on multiple images take with suitable camera angles. Moreover, it is possible to provide panning in all directions by providing enough images that have suitable overlap in both vertical and horizontal directions. Other variations will also occur to those skilled in the art upon consideration of the current teachings.

Those skilled in the art will recognize, upon consideration of the present teachings, that the present invention has been described in terms of exemplary embodiments based upon use of a programmed processor such as controller 154. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate, in view of this teaching, that the program steps and associated data used to implement the embodiments described above can be implemented using disc storage as well as other forms of storage such as for example Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention, as described in certain embodiments herein, is implemented using a programmed processor executing programming instructions that are broadly described above in flow chart form that can be stored on any suitable electronic storage medium or transmitted over any suitable electronic communication medium. However, those skilled in the art will appreciate, upon consideration of this teaching, that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

1. A method of displaying a view of a scene on an electronic display, comprising:
presenting a main window;
presenting a secondary window adjacent the main window;
providing a first and a second image, wherein the first and second images overlap one another by at least 50%;
removing a portion of the first image and displaying a remainder of the first image in the main window;
removing a portion of the second image and displaying a remainder of the second image in the secondary window; and
wherein, a composite image comprising the remainder of the first image displayed adjacent the remainder of the second image provides a selected view extracted from a total scene captured in the sum of the first and second images.

2. The method according to claim 1, wherein the first and second image are taken by multiple camera angles from a single camera location.

3. The method according to claim 1, wherein the composite image is displayed on a television display, and wherein the secondary window comprises a picture-in-picture window.

4. The method according to claim 1, wherein the first and second images are identified within a transport stream by first and second packet identifiers respectively.

5. The method according to claim 1, wherein the first and second images are identified within a recorded medium by first and second packet identifiers respectively.

6. The method according to claim 1, further comprising:
receiving a command to pan the view;
identifying portions of the first and second images to remove in order to create the remainder of the first image and the remainder of the second image to produce the panned view;
removing the identified portions of the first and second images to create the remainder of the first image and the remainder of the second image to produce the panned view; and
displaying the panned view by displaying the remainder of the first image and the remainder of the second image in the main and secondary windows respectively.

7. The method according to claim 1, carried out in one of a DVD player, a personal computer system, a television set-top-box and a personal computer system.

8. A computer readable storage medium storing instructions that, when executed on a programmed processor, carry out a process according to claim 1.

9. A method of displaying a view of a scene on an electronic display, comprising:
presenting a main window;
presenting a picture-in-picture (PIP) window adjacent the main window;
receiving a transport stream;
receiving a first and a second image from the transport stream, wherein the first and second images are identified within the transport stream by first and second packet identifiers respectively, wherein the first and second images overlap one another by at least 50%, and wherein the first and second image are taken by multiple camera angles from a single camera location;
removing a portion of the first image and displaying a remainder of the first image in the main window;
removing a portion of the second image and displaying a remainder of the second image in the PIP window;
wherein, a composite image comprising the remainder of the first image displayed adjacent the remainder of the second image provides a selected view extracted from a total scene captured in the sum of the first and second images;
the method further comprising:
receiving a command to pan the view;
identifying portions of the first and second images to remove in order to create the remainder of the first image and the remainder of the second image to produce the panned view;
removing the identified portions of the first and second images to create the remainder of the first image and the remainder of the second image to produce the panned view; and
displaying the panned view by displaying the remainder of the first image and the remainder of the second image in the main and PIP windows respectively.

10. A device for producing a view of a scene, comprising:
a demultiplexer that receives an input stream as an input and produces a first video stream and a second video stream as outputs, wherein the first video stream represents a first video image of the scene and wherein the second video stream represents a second video image of the scene;
a main decoder receiving the first video stream;
a secondary decoder receiving the second video stream;
means for removing portions of the first and second images to leave remaining portions of the first and second images;
an image combiner that combines the first and second images to produce a composite image, wherein the composite image represent a view of the scene.

11. The device according to claim 10, wherein the composite image is displayed in a pair of adjacent windows.

12. The device according to claim 10, wherein the first and second image are created taken by multiple camera angles from a single camera location.

13. The device according to claim 10, wherein the composite image is displayed on a television display, and wherein the secondary window comprises a picture-in-picture window.

14. The device according to claim 10, wherein the first and second images are identified within a transport stream by first and second packet identifiers respectively, and wherein the demultiplexer demultiplexes the transport stream by packet filtering.

15. The device according to claim 10, wherein the first and second images are identified within a recorded medium by first and second packet identifiers respectively.

16. The device according to claim 10, further comprising:
an interface for receiving a command to pan the view in order to present a panned view;
a controller that identifies portions of the first and second images to remove to create the remainder of the first image and the remainder of the second image to produce the panned view; and
means for removing the identified portions of the first and second images to create the remainder of the first image and the remainder of the second image to produce the panned view.

17. The device according to claim 10, embodied in one of a DVD player, a personal computer system, a television and a television set-top-box.

18. A method of creating multiple images for facilitating display of a selected panned view of a scene, comprising:
capturing a first image of a scene from a location using a first camera angle;
capturing a second image of the scene from the location using a second camera angle, wherein the first and second images have at least 50% overlap;
associating the first image with a first packet identifier;
associating the second image with a second packet identifier; and
formatting the first and second images in a digital format.

19. The method according to claim 18, wherein the digital format comprises an MPEG compliant format.

20. The method according to claim 18, further comprising storing the first and second images in the digital format.

21. The method according to claim 18, further comprising transmitting the first and second images in a digital transport stream.

22. A method of displaying an image on an electronic display, comprising:
presenting a main window;
presenting a secondary window adjacent the main window;
providing a first and a second image, wherein the first and second images overlap one another;
stitching together the first and second images to produce a panoramic image; and
from the panoramic image, generating first and second display images for display in the main and secondary windows such that a view from the panoramic image spans the main and secondary windows.

23. The method according to claim 22, further comprising:
displaying the a first display image in the main window; and
displaying the second display image in the secondary image window.

24. The method according to claim 22, wherein the first and second image are created from images taken by multiple camera angles from a single camera location.

25. The method according to claim 22, wherein the view is displayed on a television display, and wherein the secondary window comprises a picture-in-picture window.

26. The method according to claim 22, wherein the first and second images are identified within a transport stream by first and second packet identifiers respectively.

27. The method according to claim 22, wherein the first and second images are identified within a recorded medium by first and second packet identifiers respectively.

28. The method according to claim 22, further comprising:
receiving a command to pan the view;
identifying portions of the panoramic image that represent the panned view; and
generating first and second display images for display in the main and secondary windows such that the panned view from the panoramic image spans the main and secondary windows.

29. The method according to claim 22, carried out in one of a DVD player, a personal computer system, a television and a television set-top-box.

30. A computer readable storage medium storing instructions that, when executed on a programmed processor, carry out a process according to claim 22.

31. A method of displaying a view of a scene on an electronic display, comprising:
presenting a main window;
presenting a secondary window adjacent the main window;
providing a first and a second image, wherein the first and second images overlap one another by J%;
removing a portion of the first image and displaying a remainder of the first image in the main window;
removing a portion of the second image and displaying a remainder of the second image in the secondary window; and
wherein, a composite image comprising the remainder of the first image displayed adjacent the remainder of the second image provides a selected view extracted from a total scene captured in the sum of the first and second images.

32. The method according to claim 31, further comprising selecting a size of the main window and selecting a size of the secondary window.

33. The method according to claim 31, wherein J<50%.

34. The method according to claim 31, wherein the first and second image are taken by multiple camera angles from a single camera location.

35. The method according to claim 31, wherein the composite image is displayed on a television display, and wherein the secondary window comprises a picture-in-picture window.

36. The method according to claim 31, wherein the first and second images are identified within a transport stream by first and second packet identifiers respectively.

37. The method according to claim 31, wherein the first and second images are identified within a recorded medium by first and second packet identifiers respectively.

38. The method according to claim 31, further comprising:
receiving a command to pan the view;
identifying portions of the first and second images to remove in order to create the remainder of the first image and the remainder of the second image to produce the panned view;
removing the identified portions of the first and second images to create the remainder of the first image and the remainder of the second image to produce the panned view;
selecting a size of the main window;
selecting a size of the secondary window; and
displaying the panned view by displaying the remainder of the first image and the remainder of the second image in the main and secondary windows respectively.

39. The method according to claim 31, carried out in one of a DVD player, a personal computer system, a television set-top-box and a personal computer system.

40. A computer readable storage medium storing instructions that, when executed on a programmed processor, carry out a process according to claim 31.
